(19) United States
(12) Patent Application Publication
(10) Pub. No.: US 2004/0144825 A1
(43) Pub. Date: Jul. 29, 2004

(54) Household wrap dispenser

(76) Inventor: Anthony Peter Vandenberg, Charlotte, NC (US)

Correspondence Address: Anthony Peter Vandenberg, 600 Heather Lane, Charlotte, NC, 28209, US

(21) Appl. No.: 10/350,940

(22) Filed: Jan. 24, 2003

(51) Int. Cl. B26F 3/02

(52) U.S. Cl. 225/23; 225/41

(57) ABSTRACT

A household wrap dispenser which can be used for providing quick, convenient, safe, easy and controlled dispensing of household wraps. The wrap dispenser compromises: a transparent container for storing and allowing the free rotation of a roll of wrap; an integral rotation lid with compression arm and compression press surface for threading wrap, removing length of wrap for subsequent dispensing and cutting for present dispensing; a latch knob for securing rotation lid in the closed position and preventing rotation lid from opening unintentionally; a wrap guide and sleeve plate for controlling wrap transfer; a recessed cutting chamber and blade for the safe cutting of wrap; hinges and return springs for returning rotation lid and compression arm to original position after cutting, allowing for the next operation and access to remaining wrap end.

### BACKGROUND

1. Field of Invention

This invention relates to a household wrap dispenser utilized for quick, accurate and safe dispensing of common household wraps, food service films and foils. For purposes of simplification these dispensed articles will be collectively referred to as “wrap or wraps”.

2. Description of Related Art

Various inventions have been registered which provide improvements and utility in regards to housing, delivery and dispensing of household wraps, using various forms of tearing wrap by laterally pulling across a serrated blade with dispensing hand, or by sliding a manually activated saw blade across wrap, typically requiring repositioning of dispensing hand and causing undesirable momentum of dispensed wrap immediately following the completion of the cut. This momentum typically causes the lighter more following the completion of the cut. This momentum typically causes the lighter more flexible wraps to fly out of control, fold over, twist and stick together in frustrating configurations. With prior arts during loading or dispensing the user is exposed to the possibility of contact with the cutting blade and injury. Nothing in the patent search was found in which a dispenser utilizes an integral rotation lid as a primary threading device and a cutting press entering into a recessed cutting chamber, extracting out a length of wrap from the roll, and forcibly and uniformly contacting with a cutting blade, cutting efficiently, easily and also leaving a portion of wrap accessible for the next dispensing operation, without the use of tearing motion, undesirable momentum, or repositioning of hand(s) to activate.

### OBJECT AND ADVANTAGES

Several objects and advantages of my invention are:

(a) to provide a wrap dispenser with a rigid transparent body structure that users can store household wrap rolls in, and see the amount of wrap remaining;

(b) to provide a wrap dispenser with a rotation lid that threads wrap through a sleeve plate and leaves a portion of the wrap accessible for future dispensing;

(c) to provide a wrap dispenser with a sleeve plate and guide rail that prevents wrap from sliding back into the storage container and returning to the roll;

(d) to provide a wrap dispenser that can be used safely without the user coming into contact with the cutting blade and scratching injury during loading or dispensing;

(e) to provide a wrap dispenser that can be used easily with two hands; the front hand pulling wrap to the desired length and holding stationary, the back hand holding container and activating the cutting mechanism by compressing the rotation lid, cutting without undesirable momentum of the wrap itself, for easy and accurate dispensing;

Still further objects and advantages will become apparent from a consideration of the ensuing description and drawings.

### DRAWING FIGURES

Although the present embodiment of this invention is made from transparent molded thermoplastics, some visible objects behind the target object are not shown for greater figure clarity

FIG. 1: shows a front view of the wrap dispenser and view of exterior.

FIG. 2: shows a section view through the center of the wrap dispenser and the main interior components of the wrap dispenser.

FIG. 3: shows a side view of the wrap dispenser being loaded with wrap roll and location of hinges and return springs.

FIG. 4: shows a side view of the wrap dispenser loaded and ready for use

FIG. 5: shows a section view of the threading operation of wrap by rotation lid.

FIG. 6: shows a section view of the dispensing operation of wrap by compression and release of rotation lid against blade in cutting chamber.

### REFERENCE NUMERALS IN DRAWINGS

1 Container

2 Guard Rail

3 Cutting Chamber

4 Blade

5 Wrap Guide

6 Sleeve Plate

7 Rotation Lid

8 Compression Arm

9 Compression Press

10 Latch Knob

11 Hinges

12 Return Springs

13 Wrap

### SUMMARY

In accordance with the present invention a household wrap dispenser which compromises: a transparent container for storing and allowing the free rotation of a roll of wrap; an integral rotation lid with compression arm and compression press surface for threading wrap, removing length of wrap for subsequent dispensing and cutting for present dispensing; a latch knob for securing rotation lid in the closed position and preventing rotation lid from opening unintentionally; a wrap guide and a sleeve plate for controlling wrap transfer; a recessed cutting chamber and a blade for the safe cutting of wrap; hinges and return springs for returning rotation lid and compression arm to original position after cutting, allowing for the next operation and access to remaining wrap end; for the purpose of providing quick, convenient, safe, easy and controlled dispensing of household wraps.

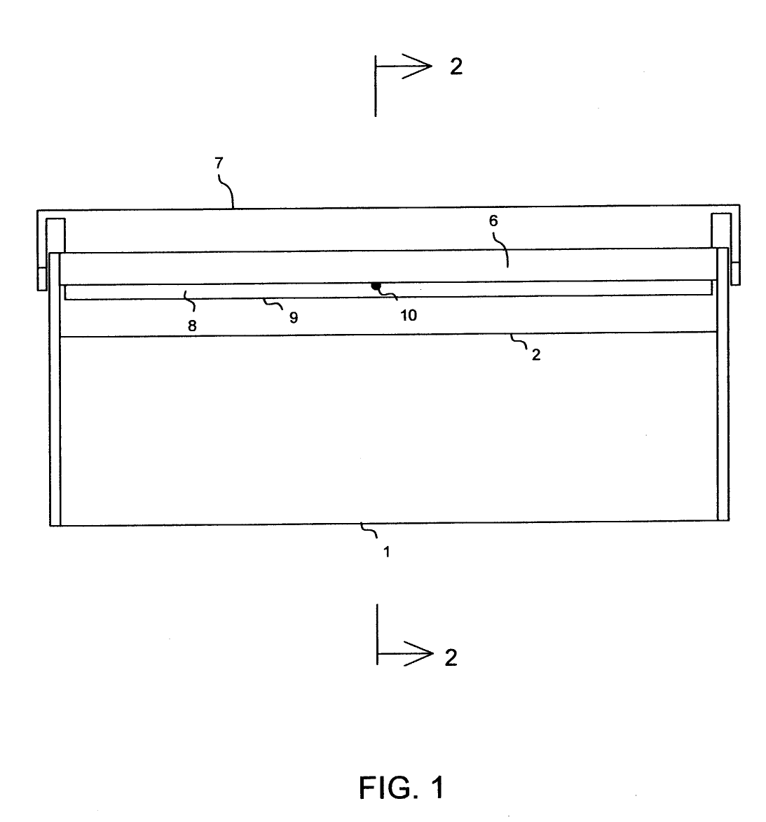

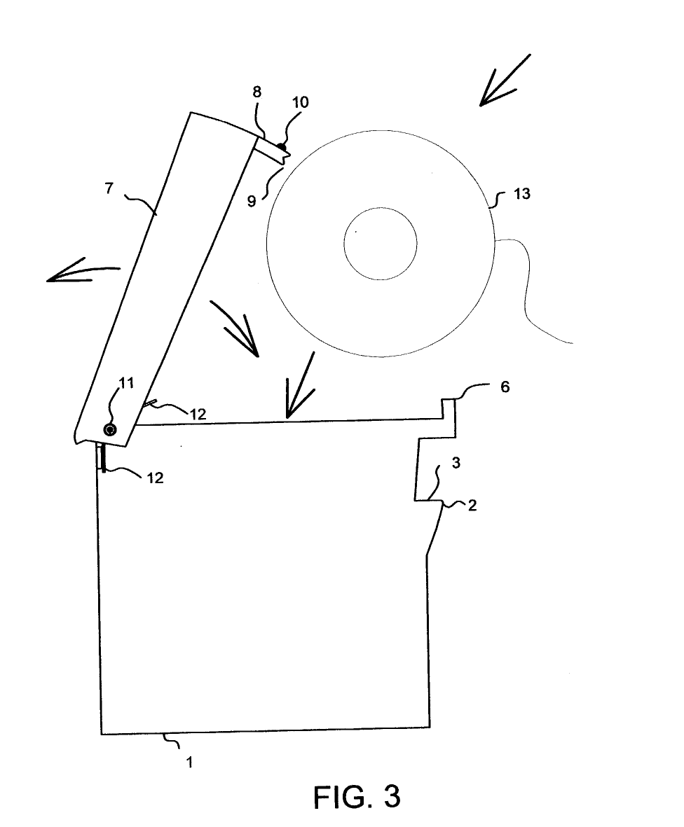

Description—FIGS. 1-6

A typical embodiment of the wrap dispenser of the present invention is illustrated in FIGS. 1-6, with typical dimensions of 300 mm length×50 mm width×65 mm height and a rectangular hollow body for storing a roll of wrap 13. The present embodiment of this invention is for dispensing of common household wraps. A typical embodiment of the wrap dispenser would be made primarily from clear transparent molded thermoplastics. Other embodiments of this invention may include different dimensional configurations and surface coatings to accommodate different wraps, foils and films.

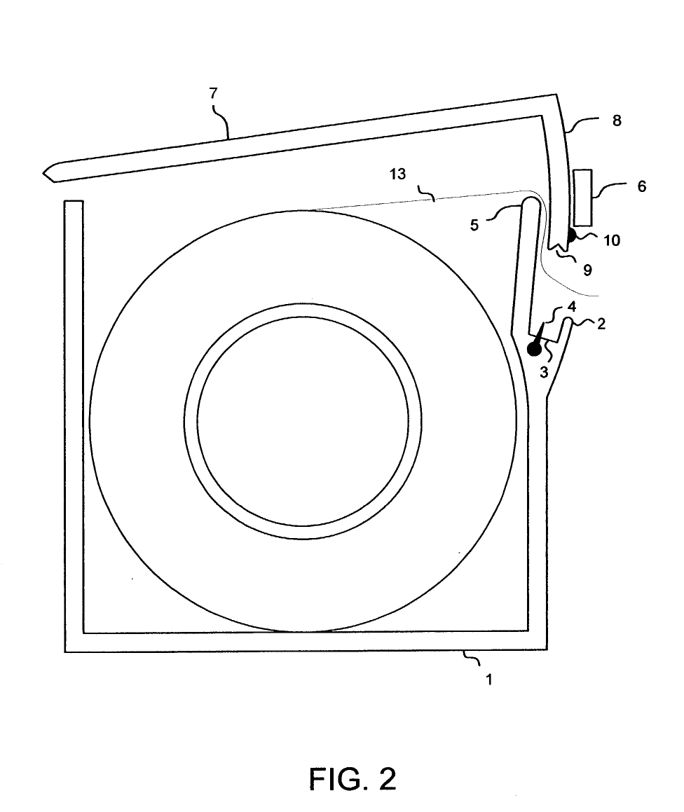

The wrap dispenser has a container 1 with four walls forming a rectangular hollow tray in which a roll of wrap 13 is stored and freely rotates during dispense operations typical of commonly used disposable household dispensers. The front interior wall of container 1 spits inward toward the roll and ends in a sloped, rounded wrap guide 5. From the split juncture, wrap guide 5 is typically set slanted back outward to the front of container 1 at a five degree angle from vertical, FIG. 2. Wrap guide 5 serves as the first guide for wrap 13 as it leaves to exterior of container 1. Located typically 20 mm below the top of wrap guide 5 on the exterior of container 1 front wall is a recessed cutting chamber 3 running the length of the front wall of container 1. Cutting chamber 3 is formed by the exterior, slanted side of wrap guide 5 and an outward protruding guard rail 2 on the exterior split of the front wall of container 1. Total width at aperture of cutting chamber 3 is typically 3.5 mm so even a small person's finger can not enter cutting chamber 3. Embedded along entire base of cutting chamber 3 is a blade 4 protruding upward to typically half the height of cutting chamber 3. Elevation of the tip of blade 4 is lower than guard rail 2 to prevent contact with blade 4 by user even if finger is accidentally pushed against the aperture. Connected to the top, front corners of the side walls of container 1 is a sleeve plate 6. The interior vertical surface of sleeve plate 6 is slight curved and is situated adjacent to the front surface of wrap guide 5 forming a thread channel, FIG. 1 and FIG. 2.

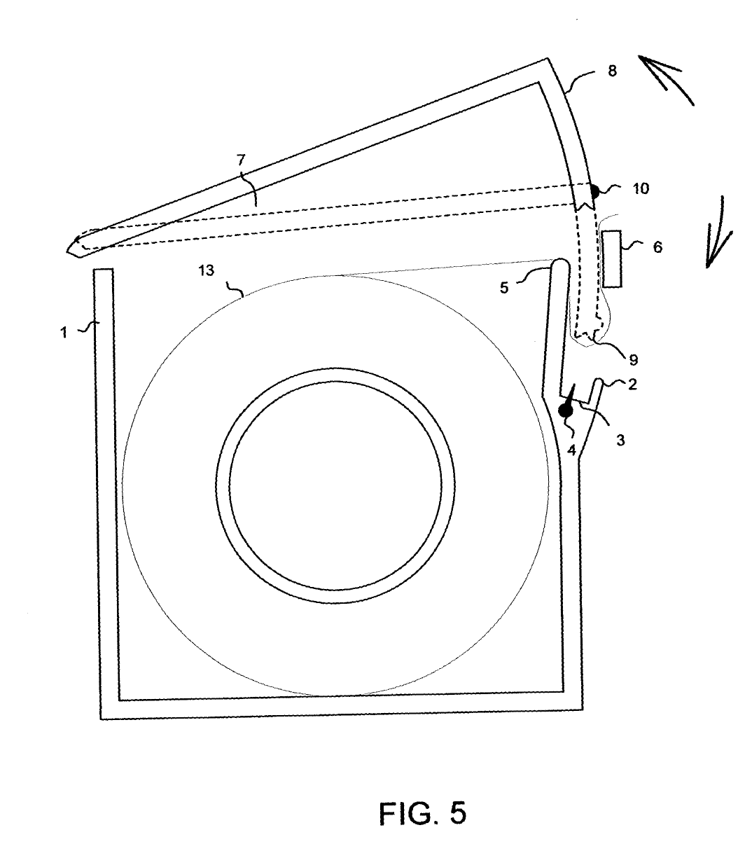

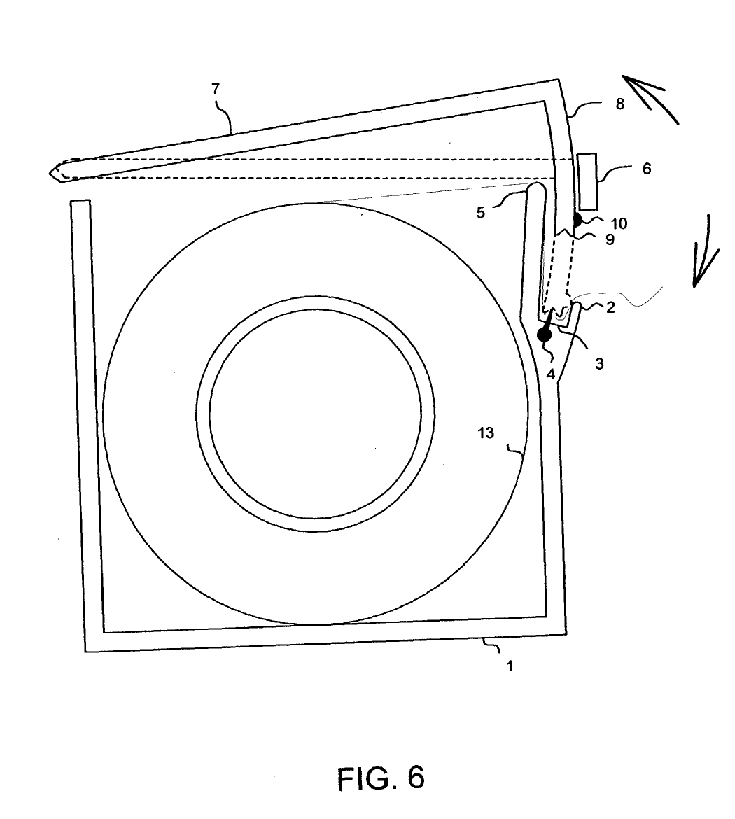

On the top, back corners of the side walls of container 1 are holes and slots for the fitting of hinges 11 and return springs 12. A rotation lid 7 is attached to container 1 via hinges 11 and rotates around the axis. The sides of rotation lid 7 overlap the exterior side walls of container 1. The front edge of rotation lid 7 is composed of an integral curved compression arm 8 typically 2 mm in thickness. The origin of the radius for compression arm 8 is the center of hinges 11 axis. The outer radius of compression arm 8 is typically 0.3 mm shorter than the radius of the inner vertical face of sleeve plate 6 allowing for passage during rotation. Compression arm 8 is typically 0.5 mm shorter than the interior length dimension of container 1, allowing for compression arm 8 to rotate down and between guard rail 2 and sleeve plate 6 into cutting chamber 3, FIG. 1, FIG. 2 and FIG. 5. The interior surface of compression arm 8 is also curved with the same radius origin at axis of hinges 12. On the bottom face of compression arm 8 is carved a ridged compression press 9, FIG. 2 and FIG. 6. The apex of the triangle shaped indent of compression press 9 is along the same radius as the alignment of blade 4 allowing for the tip of blade 4 to be struck directly in the center of compression press 9. The two outer lower ridges of compression press 9 allow for wrap 13 to be stretched taunt across the surface when compression contact is made with blade 4.

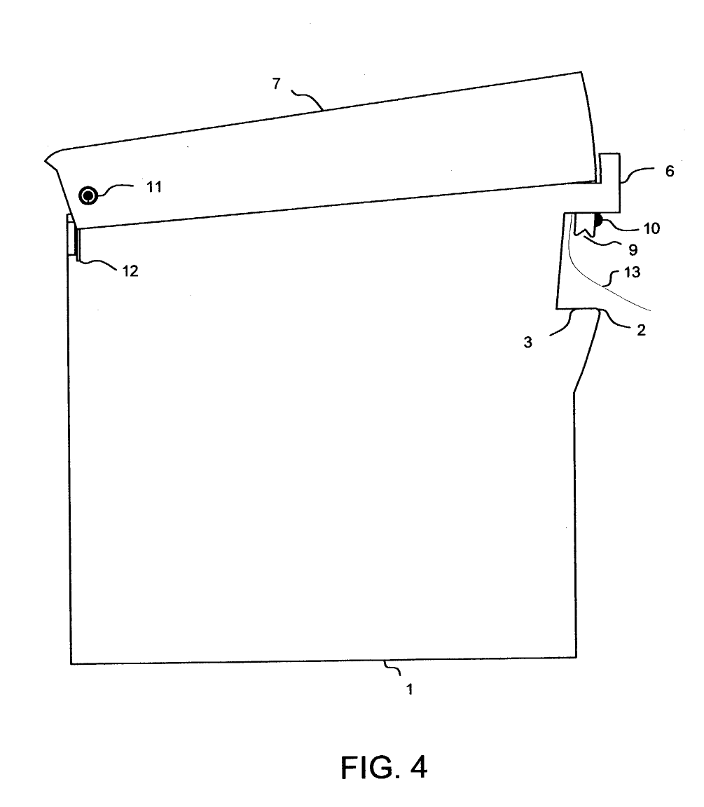

On the outer surface of compression arm 8 located just above the bottom, center edge is a hemispherical latch knob 10. Latch knob 10 protrudes from the surface of compression arm 8 typically 0.8 mm. When rotation lid 7 is forcibly rotated into the closed or open position latch knob 10 strikes the interior corner edges of sleeve plate 6 causing it to slightly deflect outward allowing compression arm 8 to pass through, FIG. 5. Once latch knob 10 passes through sleeve plate 6 returns to its normal position. The base pins of return springs 12 are fixed against slots on exterior sides of container 1, FIG. 4. The top pins of return springs 12 are set free without connection, at an angle which allows the pins to come in contact with the underside of rotation lid 7 at angle, pushing it upward so that latch knob 10 edge catches on the lower corner edge of sleeve plate 6 and is held tight when no external pressure is forced down on rotation lid 7, FIG. 1 and FIG. 5.

Operation—FIGS. 1-6

User opens rotation lid 7 by pulling up and forcing latch knob 10 to push and pass by sleeve plate 6. Rotation lid 7 is rotated all the way to vertical standing position. A roll of wrap 13 is freely placed into container 1 and a small portion of wrap 13 is draped over and past the outer edge of sleeve plate 6. Rotation lid 7 is then shut until latch knob 10 snaps into place on bottom, corner edge of sleeve plate 6 and at this angle return springs 12 are under load pushing upward. This closing action of rotation lid 7 forces compression arm 8 to thread wrap 13 between wrap guide 5 and sleeve plate 6, to exterior of container 1, FIG. 5. Excess exterior wrap can be cut away by following the normal dispense cutting steps below. Wrap dispenser is now loaded and ready for use.

User holds container in one hand with the thumb and inner portion of the hand firmly gripping rotation lid 7 and fingers wrapped around holding the back side and bottom of container 1. The other hand grabs the trailing edge of wrap 13 and pulls the wrap 13 from just above cutting chamber 3 out to desired length. During this pulling dispense phase wrap roll rotates freely in container 1 as wrap 13 slides over wrap guide 5 and across the surface of retracted compression press 9 providing tension so that the roll does not gain speed and over-rotate. At desired length the pulling hand is held stationary and the holding hand squeezes in a short burst of gripping motion rotating the rotation lid 7, compression arm 8, and compression press 9 completely downward until full contact. Compression press 9 immediately strikes wrap 13 pulling downward and causing length of wrap 13 equal to the length of the arc rotation to be reeled off wrap 13 roll. As the compression press 9 continues downward in the rotation, wrap 13 is stretched taunt across the two ridges of compression press 9 surface and wrap 13 is pushed through tip of blade 4 and cut instantly, FIG. 6.

The hand pressure is released and return springs 12 push rotation lid 7 back up to the resting position with latch knob 10 pushed up firmly against the lower corner edge of sleeve plate 6. The five degree from vertical outward slant angle of wrap guide 5 and the inner radial curvature of compression arm 8, provide sufficient gap so that during a rotation, wrap 13 contact is limited to the top outermost edge of wrap guide 5 and inner corner edge of compression press 9 ridge, thereby reducing the chance of wrap 13 coming into contact with and becoming stuck to either surface during a pull rotation or return rotation of compression arm 8. Since compression press 9 has pulled out wrap 13 during the downward rotation and cut at the end of the arc rotation, when compression arm 8 returns to its resting position, a portion of wrap 13 is left above cutting chamber 3 on the exterior of container 1 for convenient retrieval for the next dispense operation.

### SUMMARY, RAMIFICATIONS, AND SCOPE

Accordingly, the reader will see that my invention will be convenient, safe, and accurate for dispensing household wraps. Furthermore, my invention has the additional advantages in that:

(a) it provides a way to store and view remaining wrap contents.

(b) it provides a greater level of safety for everyone in the household including small children who may come in contact with the dispenser.

(c) it provides an efficient and frustration-less way of dispensing of household wraps.

Although the description above contains many specificities, these should not be construed as limiting the scope of the invention but as merely providing illustrations of some of the presently preferred embodiments of this invention. For example the wrap dispense could:

(a) have components with different shapes, levels of transparency, or portions colored or translucent;

(b) have a different dimensional configurations to accommodate larger/smaller wrap types;

(c) uses different types of blades, razor blades, serrated blades, moving blades, instant heat wire cutter or other cutting instrument in cutting chamber upon which compression press contacts wrap;

(d) have graduations on the display storage container so that user could more accurately estimate the remaining wrap contents;

e) have friction, adhesive, or smooth non-stick polish finish coatings on components to aid, restrict, and/or control dispense rates for different types of household wraps.

Thus the scope for the invention should be determined by the appended claims and their legal equivalents, rather than by the examples given.

I claim:

1. A wrap dispenser for efficient, quick and safe dispensing of household wraps, compromising:
(a) a transparent hollow, rectangular storage container for display of wrap contents,
(b) an integral wrap guide, sleeve plate, cutting chamber, blade and guard rail for guiding and controlling wrap and maintaining safety during loading and dispensing,
(c) a rotation lid with hinges and latch knob for opening and securing closed,
(d) a rotation lid with return springs and latch knob for automatically returning lid to the set position after cutting,
(e) a rotation lid with integral compression arm and compression surface for threading the original loaded wrap to the exterior of container,
f) a rotation lid with integral compression arm and compression press surface for pulling wrap down into recessed cutting chamber a distance below the point of exit of wrap from container, for subsequent access to the remaining wrap end and prevention of wrap from returning back into container,
g) a rotation lid with integral compression arm in conjunction with a wrap guide which tension wrap across a compression press surface for cutting of wrap against a blade with a short burst of squeezing movement from a single hand holding container,
whereby said wrap dispenser will allow users to accurately cut and dispense wrap without undesirable momentum of wrap flying off caused by typical lateral pull across-cut dispensers, and
whereby said wrap dispenser will allow users to easily load and thread the wrap for future use, and
whereby said wrap dispenser will allow users to easily access the remaining edge of cut wrap and prevent wrap from returning back into container, and
whereby said wrap dispenser will provides guardians, parents, and users a safe way to store, load and dispense household wraps.
